(19) United States
(12) Patent Application Publication
(10) Pub. No.: US 2011/0016650 A1
(43) Pub. Date: Jan. 27, 2011

(54) Cleaning tool

(76) Inventor: Jack K. H. Wang, Taipei County (TW)

Correspondence Address: MORRISON & FOERSTER LLP, 755 PAGE MILL RD, PALO ALTO, CA, 94304-1018, US

(21) Appl. No.: 12/589,467

(22) Filed: Oct. 23, 2009

(30) Foreign Application Priority Data
Jul. 21, 2009 (TW) 098213313

(51) Int. Cl. B25G 1/00

(52) U.S. Cl. 15/144.1

(57) ABSTRACT

A cleaning tool includes an arcuate handle member connected to a cleaning member. The handle member includes an outer tube having opposite first and second end portions, and an inner tube having opposite first and second end parts. The inner tube has the first end portion sleeved thereon. The second end part is extended movably into the outer tube. The inner tube has a plurality of engaging holes between the first and second end parts. An engaging component is disposed pivotably on the first end portion and is movable relative to the handle member between an engaging position, where the engaging component engages removably one of the engaging holes so as to secure the second end part inside the outer tube, and a free position, where the engaging component is disengaged from the engaging holes to permit movement of the second end part inside and along the outer tube.

### CROSS-REFERENCE TO RELATED APPLICATION

This application claims priority of Taiwanese Application No. 098213313, filed on Jul. 21, 2009.

### BACKGROUND OF THE INVENTION

1. Field of the Invention

The present invention relates to a cleaning tool, more particularly to a cleaning tool with an adjustable handle length.

2. Description of the Related Art

Referring to FIG. 1, a conventional cleaning tool 91 usually consists of a straight handle body 911 for handling by a user 92 to hold, and a cleaning component 912 connected to one end of the handle body 911. The cleaning component 912 can be a brush, apiece of cloth, a scraper, etc.

When using the conventional cleaning tool 91, the user 92 may often be unable or find it difficult to reach positions higher and non-perpendicular with respect to the user 92, such as a vehicle roof 93 shown in FIG. 1. As shown in FIG. 1, to clean the vehicle roof 93 using the cleaning tool 91, the user 92 raises the handle body 911 to a position higher than the vehicle roof 93 in order for the cleaning component 912 to be disposed on an upper surface of the vehicle roof 93. This, however, requires the user 92 raises to raise his arms to a higher position, and makes exerting force to the cleaning component 912 difficult. Thus, the cleaning tool 91 is inconvenient to use.

### SUMMARY OF THE INVENTION

Therefore, an object of the present invention is to provide a cleaning tool suitable for reaching positions higher and non-perpendicular with respect to the user.

Accordingly, a cleaning tool of the present invention includes an arcuate handle member and a cleaning member. The handle member includes an arcuate outer tube, an arcuate inner tube, and an engaging component. The outer tube has a first end portion and a second end portion opposite to the first end portion. The inner tube has a first end part and a second end part opposite to the first end part. The inner tube has the first end portion of the outer tube sleeved thereon. The second end part is extended movably into the outer tube. The inner tube is formed with a plurality of engaging holes between the first end part and the second end part. The engaging component is disposed pivotably on the first end portion of the outer tube. The engaging component is movable relative to the handle member between an engaging position, where the engaging component engages removably one of the engaging holes in the inner tube so as to secure the second end part of the inner tube inside the outer tube, and a free position, where the engaging component is disengaged from the engaging holes in the inner tube so as to permit movement of the second end part of the inner tube inside and along the outer tube. The cleaning member is disposed on one of the first end part of the inner tube and the second end portion of the outer tube.

The arcuate handle member of the present invention is more suitable for reaching positions higher and non-perpendicular with respect to the user, permits the user to hold the cleaning tool at a relatively lower position, and facilitate the exertion of force to the cleaning member.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a scenario in which a conventional cleaning tool is used for reaching positions higher and non-perpendicular with respect to a user;

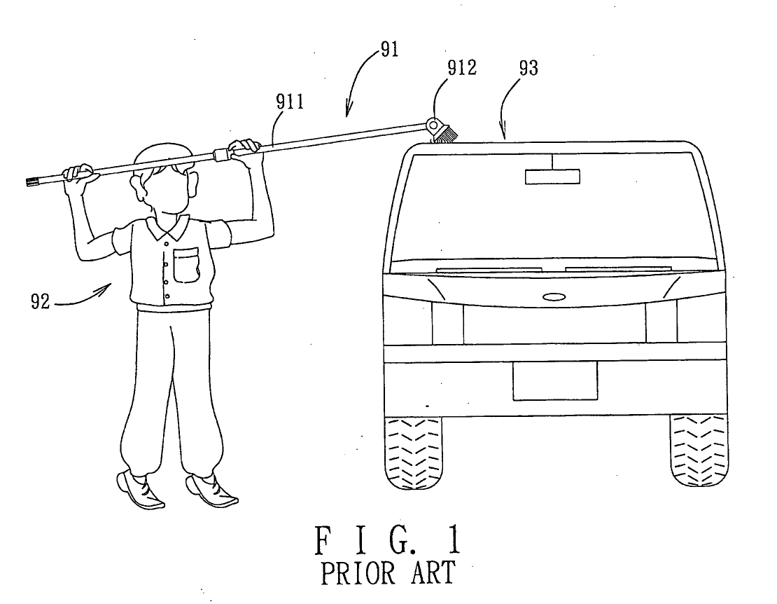

FIG. 2 is a perspective view illustrating the preferred embodiment of a cleaning tool according to the present invention;

FIG. 3 is a schematic sectional view of the preferred embodiment illustrating an engaging component at an engaging position;

FIG. 4 is a schematic sectional view of the preferred embodiment illustrating the engaging component at a free position; and

FIG. 5 is a schematic side view of a resilient limiting component of the preferred embodiment.

### DETAILED DESCRIPTION OF THE PREFERRED EMBODIMENT

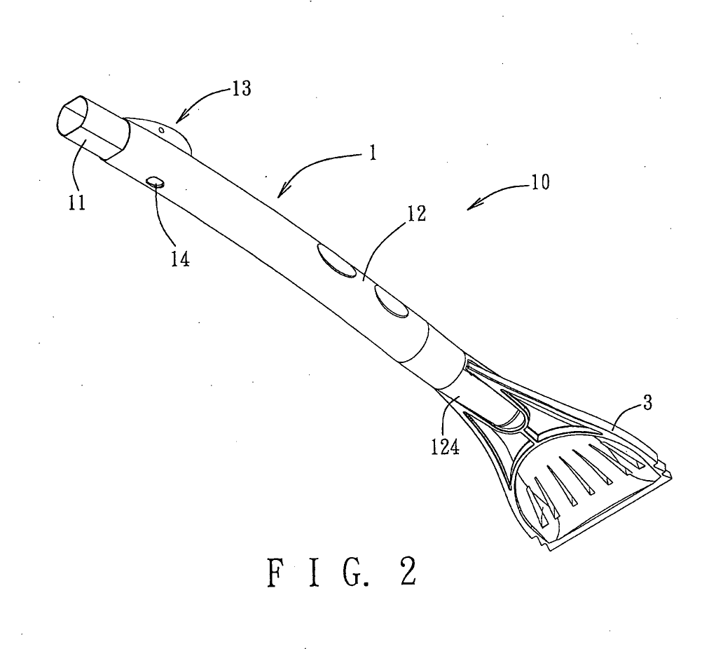

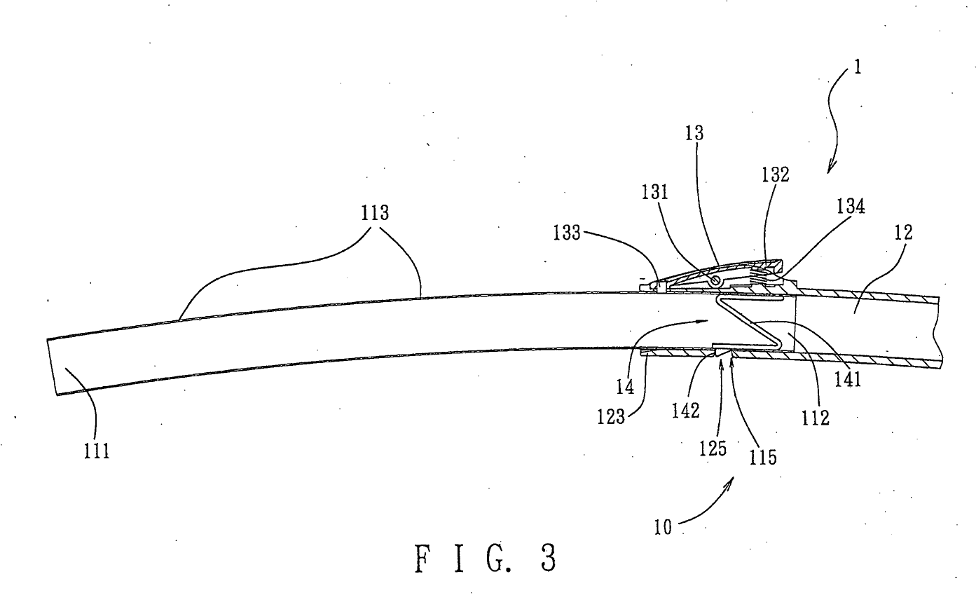

Referring to FIGS. 2 and 3, the preferred embodiment of a cleaning tool 10 according to the present invention includes an arcuate handle member 1 and a cleaning member 3. The cleaning member 3 is exemplified as an ice chipper in the present embodiment, but may be a brush, a scraper, etc. in other embodiments of the present invention.

The handle member 1 includes an outer tube 12, an inner tube 11, and an engaging component 13. The inner tube 11 is arcuate, and has a first end part 111 and a second end part 112 opposite to the first end part 111. The outer tube 12 is arcuate, and has a first end portion 123 and a second end portion 124 opposite to the first end portion 123. Each of the outer tube 12 and the inner tube 11 has a substantially oval cross-section in this embodiment. The inner tube 11 has a section abutting against an inner tube face of the outer tube 12 and extends movably into the outer tube 12. The cross-section of the inner tube 11 has dimensions substantially equal to those of the cross-section of the outer tube 12. In other words, the second end part 112 of the inner tube 11 is extended movably into the outer tube 12, and the inner tube 11 has the first end portion 123 of the outer tube 12 sleeved thereon. The inner tube 11 is formed with a plurality of engaging holes 113 between the first and second end parts 111, 112. Preferably, the inner tube 11 has an arcuate face along which the engaging holes 113 are arranged. In the present embodiment, the second end portion 124 of the outer tube 12 is gradually constricted to form a sealed end portion, and is connected to the cleaning member 3. It is to be noted that the second end portion 124 can be formed into an open end portion that has dimensions smaller than those of the second end part 112 of the inner tube 11 so as to prevent the inner tube 11 from being drawn out of the second end portion 124 of the outer tube 12. Moreover, the design of the second end portion 124 of the outer tube 12 may be varied in other embodiments of the present invention.

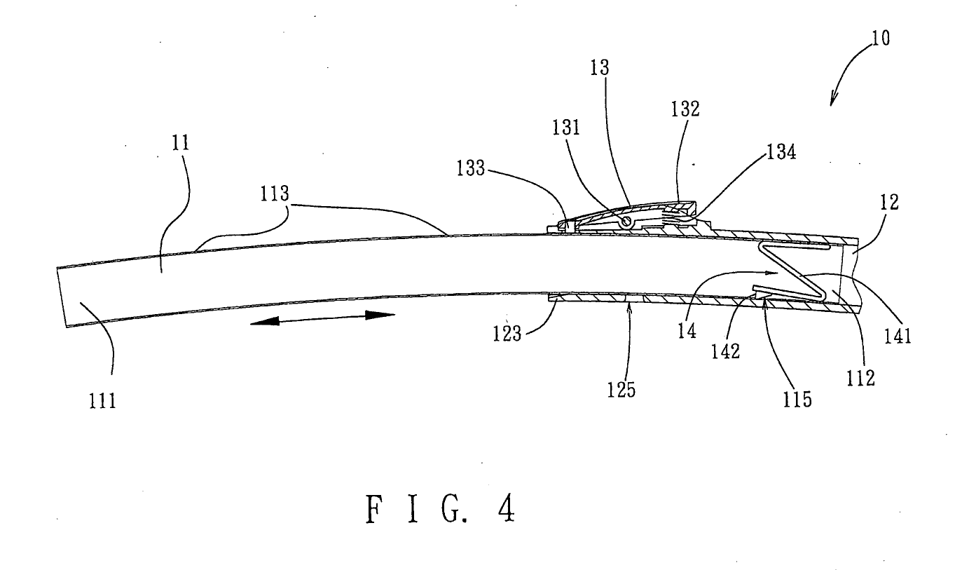

The engaging component 13 of the handle member 1 is disposed on the first end portion 123 of the outer tube 12. The engaging component 13 includes a pivot part 131 that is pivoted to the first end portion 123 of the outer tube 12, and that has opposite first and second sides. The engaging component 13 further includes a press part 132 connected to the first side of the pivot part 131, a resilient element 134 disposed between the first end portion 123 of the outer tube 12 and the press part 132, and a locking protrusion 133 connected to the second side of the pivot part 131 and extending removably into the inner tube 11 via one of the engaging holes 113. In the present embodiment, the press part 132 is biased by the resilient element 134 in a direction away from the outer tube 12. Therefore, after the user adjusts the position of the inner tube 11 relative to the outer tube 12 such that one of the engaging holes 113 is in alignment with the locking protrusion 133, the locking protrusion 133 is urged to extend removably into said one of the engaging holes 113, and the engaging component 13 is at an engaging position. As shown in FIG. 3, at the engaging position, the second end part 112 of the inner tube 11 is secured at a position inside the outer tube 12 and is unable to move along the outer tube 12. When the press part 132 of the engaging component 13 is subjected to a force sufficient to overcome a biasing force of the resilient element 134, the locking protrusion 133 of the engaging component 13 is removed from one of the engaging holes 113, and the engaging component 13 is at a free position. As shown in FIG. 4, at the free position, the second end part 112 of the inner tube 11 inside the outer tube 12 can move along the outer tube 12. In the present embodiment, the resilient element 134 is a compression spring. The resilient element 134, however, may be implemented differently in other embodiments of the present invention. It is to be noted that, although the number of selectable lengths of use for the handle member 1 corresponds to the number of engaging holes 113 in the inner tube 11, an increase in the number of engaging holes 113 compromises the overall structural strength of the handle member 1. The present embodiment has three engaging holes 113, but the number thereof can be varied in other embodiments of the present invention based on requirements.

To prevent the user from extending the handle member 1 excessively such that the inner tube 11 is drawn out of the outer tube 12, the handle member 1 further includes a resilient limiting component 14 disposed inside the second end part 112 of the inner tube 11. The second end part 112 of the inner tube 11 is further formed with a first limiting hole 115, and the first end portion 123 of the outer tube 12 is further formed with a second limiting hole 125. The outer tube 12 has a hole-defining wall that defines the second limiting hole 125. The resilient limiting component 14 has a resilient part 191 disposed in the second end part 112 of the inner tube 11, and a protrusion part 142 disposed on the resilient part 141 and protruding through the first limiting hole 115.

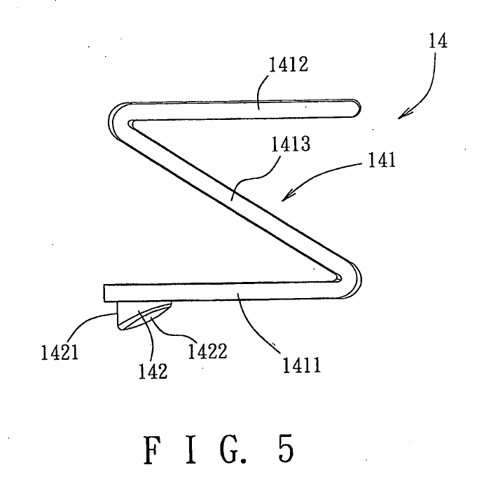

Referring to FIGS. 3, 4, and 5, in the present embodiment, the resilient part 141 includes a first resilient arm 1411 and a second resilient arm 1412 abutting respectively against two opposite sides of an inner wall face of the inner tube 11. The resilient part 141 further includes a third resilient arm 1413 interconnecting the first and second resilient arms 1411, 1412 and forming an acute angle with a lengthwise direction of the inner tube 11. The resilient part 141 is substantially Z-shaped. The protrusion part 142 of the present embodiment is disposed on one of two ends of the first resilient arm 1411 that is not connected to the third resilient arm 1413. The protrusion part 142 has a perpendicular face 1421 substantially perpendicular to the inner tube 11 and a slanted face 1422 forming an acute angle with the inner tube 11. The perpendicular face 1421 is disposed closer to the first end part 111 of the inner tube 11 compared to the slanted face 1422. The protrusion part 142 is pushed into the first limiting hole 115 by the inner tube face of the outer tube 12 when the first limiting hole 115 and the second limiting hole 125 are out of alignment, as shown in FIG. 4. In this state, the protrusion part 142 does not hinder movement of the inner tube 11 in the outer tube 12. However, the resilient part 141 biases the protrusion part 142 outwardly of the first and second limiting holes 115, 125 when the first and second limiting holes 115, 125 are in alignment, as shown in FIG. 3. In this state, the perpendicular face 1421 of the protrusion part 142 abuts against the hole-defining wall of the outer tube 12 to prevent movement of the inner tube 11 relative to the outer tube 12 along a direction from the second end part 112 toward the first end part 111 of the inner tube 11 when the protrusion part 142 extends into the second limiting hole 125 via the first limiting hole 115.

It is to be noted that, when the user pushes the inner tube 11 further toward the second end portion 124 of the outer tube 12 while the first and second limiting holes 115, 125 are in alignment, the hole-defining wall of the outer tube 12 pushes the slanted face 1422 of the protrusion part 142 such that the protrusion part 142 is pushed into the first limiting hole 115. Therefore, when the first and second limiting holes 115, 125 are in alignment, the inner tube 11 cannot be drawn out from the outer tube 12 but can be inserted further into the outer tube 12 in a direction toward the second end portion 124.

In sum, compared to the prior art, the present invention permits the user to reach positions higher and non-perpendicular with respect to the user while holding the cleaning tool 10 at a relatively lower position, thereby facilitating the exertion of force to the cleaning member 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A cleaning tool comprising:
an arcuate handle member including
an arcuate outer tube having a first end portion and a second end portion opposite to said first end portion,
an arcuate inner tube having a first end part and a second end part opposite to said first end part, said inner tube having said first end portion of said outer tube sleeved thereon, said second end part being extended movably into said outer tube, said inner tube being formed with a plurality of engaging holes between said first end part and said second end part, and
an engaging component disposed pivotably on said first end portion of said outer tube, said engaging component being movable relative to said handle member between an engaging position, where said engaging component engages removably one of said engaging holes in said inner tube so as to secure said second end part of said inner tube inside said outer tube, and a free position, where said engaging component is disengaged from said engaging holes in said inner tube so as to permit movement of said second end part of said inner tube inside and along said outer tube; and
a cleaning member disposed on one of said first end part of said inner tube and said second end portion of said outer tube.

2. The cleaning tool as claimed in claim 1, wherein said engaging component includes
a pivot part pivoted to said first end portion of said outer tube and having opposite first and second sides,
a press part connected to said first side of said pivot part, and
a locking protrusion connected to said second side of said pivot part, said locking protrusion extending removably into said inner tube via one of said engaging holes.

3. The cleaning tool as claimed in claim 2, wherein said engaging component further includes a resilient element disposed between said first end portion of said outer tube and said press part, said press part being biased by said resilient element in a direction away from said outer tube so that said locking protrusion is urged toward said inner tube when said press part is not subjected to a force sufficient to overcome a biasing force of said resilient element.

4. The cleaning tool as claimed in claim 3, wherein each of said outer tube and said inner tube has a substantially oval cross-section.

5. The cleaning tool as claimed in claim 3, wherein said inner tube has an arcuate face along which said engaging holes are arranged.

6. The cleaning tool as claimed in claim 3, wherein said second end portion of said outer tube has a cross-section with dimensions smaller than those of a cross-section of said second end part of said inner tube.

7. The cleaning tool as claimed in claim 3, wherein said second end portion of said outer tube is a sealed end portion.

8. The cleaning tool as claimed in claim 1, wherein said inner tube is formed with a first limiting hole, said outer tube having an inner tube face and a hole-defining wall that defines a second limiting hole in said outer tube, said handle member further including a resilient limiting component, said resilient limiting component having a resilient part disposed inside said inner tube, and a protrusion part disposed on said resilient part and protruding through said first limiting hole,
said protrusion part having a perpendicular face that is substantially perpendicular to said inner tube and a slanted face that forms an acute angle with said inner tube, said perpendicular face being disposed closer to said first end part of said inner tube compared to said slanted face,
said protrusion part being pushed into said first limiting hole by said inner tube face of said outer tube when said first limiting hole and said second limiting hole are out of alignment,
said resilient part biasing said protrusion part outwardly of said first limiting hole and said second limiting hole when said first limiting hole and said second limiting hole are in alignment,
said perpendicular face of said protrusion part abutting against said hole-defining wall of said outer tube to prevent movement of said inner tube relative to said outer tube along a direction from said second end part toward said first end part of said inner tube when said protrusion part extends into said second limiting hole via said first limiting hole.

9. The cleaning tool as claimed in claim 8, wherein said first limiting hole and said second limiting hole are formed in said second end part of said inner tube and said first end portion of said outer tube, respectively.

10. The cleaning tool as claimed in claim 8, wherein said inner tube has an inner wall face, said resilient part of said resilient limiting component being substantially Z-shaped and including a first resilient arm and a second resilient arm that abut respectively against two opposite sides of said inner wall face of said inner tube,
said resilient part further including a third resilient arm that interconnects said first resilient arm and said second resilient arm and that forms an acute angle with a lengthwise direction of said inner tube,
said first resilient arm having one end that is connected to said third resilient arm and another end that is provided with said protrusion part.
